(19) United States
(12) Patent Application Publication
(10) Pub. No.: US 2026/0340945 A1
(43) Pub. Date: Oct. 29, 2026

(54) INTRINSIC VECTOR HEAT NETWORK

(71) Applicant: Roblox Corporation, San Mateo, CA (US)

(72) Inventors: Alexander Wang GAO, Ann Arbor, MI (US); Maurice Kyojin CHU, Redwood City, CA (US); Hsueh-Ti LIU, Vancouver (CA); Mubbasir Turab KAPADIA, San Mateo, CA (US); Ming C. LIN, Sunnyvale, CA (US)

(73) Assignee: Roblox Corporation, San Mateo, CA (US)

(21) Appl. No.: 19/653,996

(22) Filed: Apr. 21, 2026

Related U.S. Application Data
(60) Provisional application No. 63/793,196, filed on Apr. 23, 2025.

(51) Int. Cl. G06T 17/20

(52) U.S. Cl. CPC G06T 17/20

(57) ABSTRACT

Vector fields are used to model flows for many engineering applications. Various implementations relate to generating tangent vector fields on three-dimensional objects. In some implementations, a method may include receiving as input features a set of tangent vectors defined on vertices of a triangle mesh for a surface, each tangent vector represented as a complex number, transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron, and outputting the set of tangent vector fields defined on the vertices as output features. A quadrilateral mesh may be generated for the surface based on the set of tangent of vector fields and used to render the surface.

### CROSS-REFERENCE TO RELATED APPLICATIONS

This application claims priority under 35 U.S.C. § 119(e) to U.S. Provisional Patent Application No. 63/793,196, entitled “INTRINSIC VECTOR HEAT NETWORK,” filed on Apr. 23, 2025, the content of which is incorporated herein in its entirety.

### TECHNICAL FIELD

This disclosure relates generally to computer graphics, and more particularly but not exclusively, relates to methods, systems, and computer readable media that are trained to generate tangent vector fields that are intrinsically defined on manifold surfaces embedded in a three-dimensional (3D) space.

### BACKGROUND

Vector fields are widely used to represent and model flows in many scientific and engineering applications. Existing approaches to training models to generate vector fields on surfaces treat vectors as multi-dimensional scalar fields, using existing scalar-valued architectures to process dimensions individually, and fail to preserve intrinsic properties of the vector fields.

Tangent vector fields on Riemannian manifolds are a common aspect of scientific computation, with applications ranging from modeling physical processes on Earth, to robotic navigation on complex terrains, to mesh generation.

The majority of existing works on training models to generate tangent vector fields rely on neural network architectures that include scalar neurons (e.g., a standard multilayer perceptron (MLP)). Despite being straightforward to implement, these scalar-valued architectures assume that each scalar channel can be processed independently of the others (e.g., as with RGB color channels in images).

The multiple dimensions of a directional vector are to be considered jointly, not independently. These multiple dimensions represent entangled properties (length and orientation). As an example, a simple rotation may involve adjusting all components of a vector to maintain the length of the vector.

A scalar-valued neural network does not inherently coordinate managing such vector properties. Scalar-valued architectures also disregard invariances of tangent vector fields, such as the choice of local tangent bases in which the vectors are expressed. Such disregard with respect to invariances prohibits the generalization of scalar-valued architectures to unseen data that does not share the same (arbitrary) choice of bases.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to generate tangent vector fields on three-dimensional objects is provided, the method comprising: receiving as input features a set of tangent vectors defined on vertices of a triangle mesh for a surface, each tangent vector represented as a complex number; transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and outputting the set of tangent vector fields defined on the vertices as output features.

Various implementations of the computer-implemented method are described herein.

In some implementations, the computer-implemented method further comprises generating a quadrilateral mesh for the surface based on the set of tangent vector fields.

In some implementations, the computer-implemented method further comprises rendering the surface based on the quadrilateral mesh.

In some implementations, the transforming is invariant to rigid motion of the surface, tangent bases of the surface, isometry of the surface, or a combination thereof.

In some implementations, the vector heat diffusion module processes the set of tangent vectors by solving a vector heat equation using implicit Euler integration.

In some implementations, solving the vector heat equation using implicit Euler integration comprises performing approximation using spectral acceleration to transform the set of tangent vectors into a set of diffused features.

In some implementations, the spectral acceleration uses trainable time steps to transform the set of tangent vectors into the set of diffused features.

In some implementations, the vector-valued multi-layer perceptron (MLP) includes a per-vertex linear layer to linearly combine complex-valued features at each vertex of the triangle mesh and apply non-linearities on magnitudes of respective complex-valued features of vertices of the triangle mesh.

In some implementations, the vector-valued multi-layer perceptron (MLP) includes alternating complex linear and vector activation layers.

In some implementations, the at least one vector diffusion block is preceded by an initial vector multi-layer perceptron (MLP) to prepare the set of tangent vectors for processing by modifying a number of dimensions of individual vectors in the set of tangent vectors.

In some implementations, the at least one vector diffusion block is followed by a final vector MLP to prepare the set of tangent vector fields for output by modifying a number of dimensions of individual vector fields in the set of tangent vector fields.

In some implementations, an output of the vector heat diffusion module is provided as input to the vector-valued MLP, and the vector-valued MLP generates the set of tangent vector fields.

In some implementations, the at least one vector diffusion block is configured with at least one skip connection whereby an output of the vector heat diffusion module is appended with the set of tangent vectors prior to provision as the input to the vector-valued MLP.

In some implementations, the receiving, the transforming, and the outputting use a set of scalars in addition to or instead of the set of tangent vectors, each scalar represented as a real part of a complex number.

According to another aspect, a non-transitory computer-readable medium is provided. The non-transitory computer-readable medium with instructions stored thereon that, responsive to execution by a processing device, causes the processing device to perform operations comprising: receiving as input features a set of tangent vectors defined on vertices of a triangle mesh for a surface, each tangent vector represented as a complex number; transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and outputting the set of tangent vector fields defined on the vertices as output features.

Various implementations of the non-transitory computer-readable medium are described herein.

In some implementations, the transforming is invariant to rigid motion of the surface, tangent bases of the surface, isometry of the surface, or a combination thereof.

In some implementations, the vector heat diffusion module processes the set of tangent vectors by solving a vector heat equation using implicit Euler integration.

In some implementations, the vector-valued multi-layer perceptron (MLP) includes alternating complex linear and vector activation layers.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: receiving as input features a set of tangent vectors defined on vertices of a triangle mesh for a surface, each tangent vector represented as a complex number; transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and outputting the set of tangent vector fields defined on the vertices as output features.

Various implementations of the system are described herein.

In some implementations, the transforming is invariant to rigid motion of the surface, tangent bases of the surface, isometry of the surface, or a combination thereof.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1A is a diagram of various aspects of tangent planes with respect to a point on a manifold, in accordance with some implementations.

FIG. 1B is a diagram of various aspects of basis invariant tangent vectors, in accordance with some implementations.

FIG. 1C is a diagram of parallel transport of tangent vectors, in accordance with some implementations.

FIG. 1D is a diagram of various aspects of a vector heat diffusion process, in accordance with some implementations.

FIG. 1E is a diagram of discretization(s) in a vector heat diffusion process, in accordance with some implementations.

FIG. 1F is a diagram of tangent vectors that are N-way rotationally symmetric, in accordance with some implementations.

FIG. 2 is a diagram illustrating a vector heat network, in accordance with some implementations.

FIG. 3 is a diagram illustrating a vector multi-layer perceptron (MLP), in accordance with some implementations.

FIG. 4A illustrates an architecture that is invariant to rigid transformation, in accordance with some implementations.

FIG. 4B illustrates an alternative architecture that outputs a different vector field with high error.

FIG. 5 illustrates a technique that is invariant to a choice of tangent bases, in accordance with some implementations.

FIG. 6 illustrates a technique that is invariant to isometric deformation, in accordance with some implementations.

FIG. 7 illustrates a technique that exploits the benefit of a spectral technique and gains robustness to different discretization(s), in accordance with some implementations.

FIG. 8 illustrates a technique that, after obtaining the output cross field, uses available quad mesh extraction techniques to obtain a quadrilateral mesh with edges aligned with the predicted cross field, in accordance with some implementations.

FIG. 9 illustrates vector-field-guided quadrilateral meshing results of various character heads from a test dataset, in accordance with some implementations.

FIG. 10 illustrates a training subset and test results that illustrate ways trained vector-field-guided quadrilateral remeshing can generalize to other datasets and classes of objects, in accordance with some implementations.

FIG. 11 illustrates results of an optimization-based quad meshing technique and using present techniques to faithfully reproduce the result, in accordance with some implementations.

FIG. 12 is a flowchart illustrating a method to generate tangent vector field from vectors, in accordance with some implementations.

FIG. 13 is a diagram illustrating ways a method is scalable to high resolution input meshes, in accordance with some implementations.

FIG. 14 is a diagram illustrating ways tangent vector fields are used to guide robot path planning, in accordance with some implementations.

FIG. 15 is a diagram of an example system architecture that includes a 3D environment platform to train models to generate tangent vector fields that are intrinsically defined on manifold surfaces embedded in a three-dimensional (3D) space, in accordance with some implementations.

FIG. 16 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, training a neural network architecture to generate, from tangent vectors, tangent vector fields that are intrinsically defined on manifold surfaces embedded in a three-dimensional (3D) space and using such a trained neural network in applications such as 3D object rendering, combining 3D objects, displaying 3D objects in a virtual environment, animating 3D objects, simulating 3D objects, etc. By manifold surfaces, it is meant that the neighborhood around individual points on the manifold surface resembles a two-dimensional (2D) plane locally. For example, the surface may be that of a 3D object.

Various implementations provide a trainable vector heat diffusion module to spatially propagate vector-valued feature data across the surface. Implementations incorporate such vector-valued feature data into the proposed architecture, which may include vector-valued neurons and constituent modules. In the present disclosure, a tangent vector of a given point on the surface is a 2D vector “live” on the tangent plane of the point, where the “tangent plane” is the plane that passes through the point and has the same normal vector as the point normal.

The architecture is invariant to rigid motion of the input, isometric deformation, and choice of local tangent bases. The architecture is also robust to discretization(s) of the surface. When employing the vector heat network presented in implementations on triangle meshes, the vector heat network demonstrates these useful invariant properties. The vector heat network also demonstrates effectiveness of the techniques in the context of the useful industrial application of quadrilateral mesh generation. Computer graphics pipelines designed for rectangle processing can advantageously render 3D objects whose surfaces are quadrilaterals and mesh arrangements of quadrilaterals can be advantageously processed using existing computer graphics hardware when such meshes are available.

An aspect of the techniques relates to passing signals around the surface to make predictions. If the input is an image, such a message passing operation is often defined through convolution, a filtering process with Artificial Intelligence (AI)-trained image filters. In various implementations, the input may be a triangle mesh where convolution cannot be easily defined.

In some implementations, heat diffusion is used as an alternative for doing message passing on surfaces. Trained heat diffusion of the present techniques has similarity to trained convolution filters in the image domain. For example, the heat diffusion network described herein can be used to determine an amount of time to be used to diffuse signals.

In some implementations, the diffusion time (which is the case in the trained heat diffusion) may be dynamically determined. Various examples indicate that this parameter alone may be insufficient for the computing technique (in some implementations, a machine learning technique with tunable parameters) to be optimized to accomplish complicated tasks. Various implementations also include fully connected layers in a multi-layer perceptron (MLP) to perform transformation the diffused signals into another complex signal and then perform another layer of diffusion. Such an iterative process of diffusing signals, then turning diffused signals into complex ones, and repeating the process (e.g., one or more times) provides to a powerful network architecture (such as with respect to expressiveness) empirically.

In some implementations, the iterative process may be subject to a termination condition that determines a point to stop iterating. In some implementations, a termination condition may be determined as being reached if a set number of passes of the vector diffusion blocks have occurred. In some implementations, a termination condition may be determined as being reached if a loss function satisfies a condition. In some implementations, a termination condition may be determined as being reached if training is no longer improving performance at a rate exceeding a threshold rate of performance improvement.

For example, implementations may allow the machine learning techniques to determine an amount of time to use when diffusing signals. Intuitively, a long time step means that a technique lets the vector heat propagate for a long time to reach a steady stage. A short time step means that a technique lets the vector heat to propagate for a short period of time so that the region far away from the heat source is not influenced. In various implementations, the time is set to be a trained parameter (a trainable time step) and backpropagation (or another tuning technique) updates the time steps determined by the training.

Tangent vector fields are commonly used for creating triangle or quad (an abbreviated term used in lieu of quadrilateral) meshes. Some meshing techniques take the tangent vector field as the input and then extract a mesh that is aligned with the input tangent vector field.

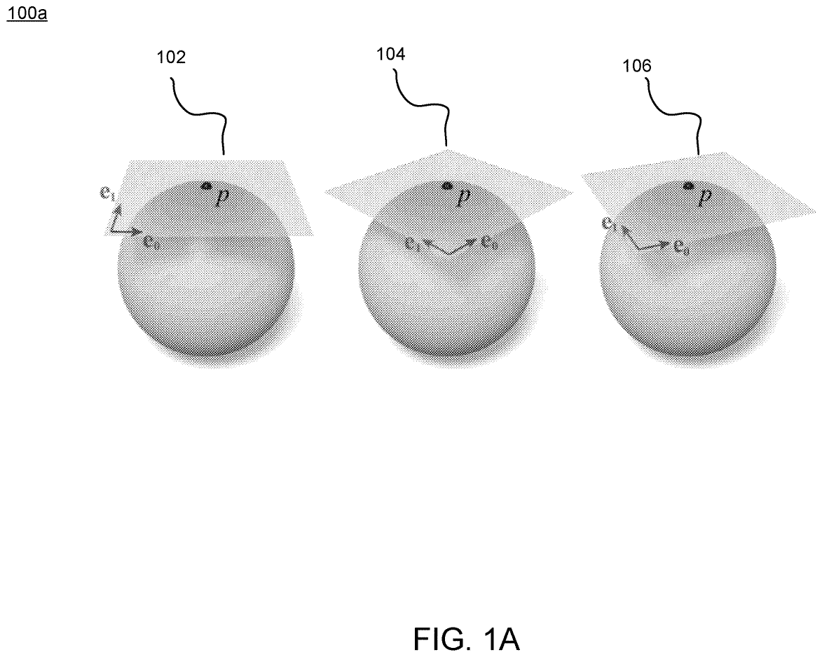

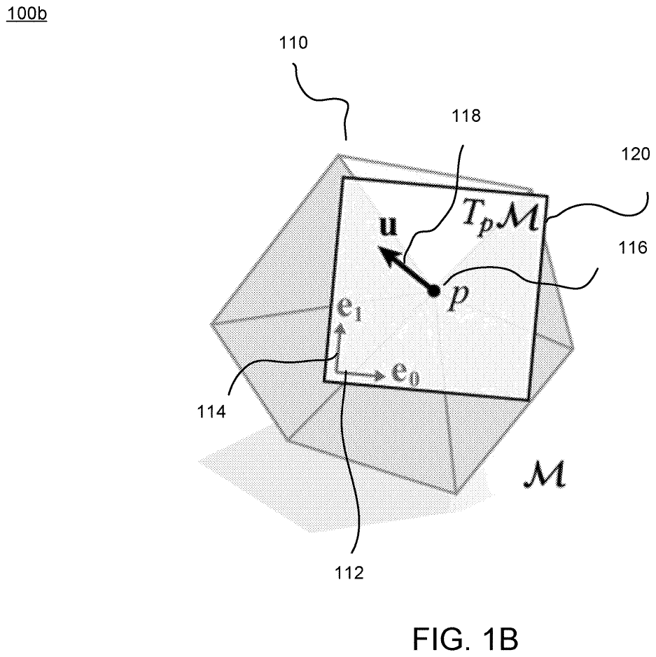

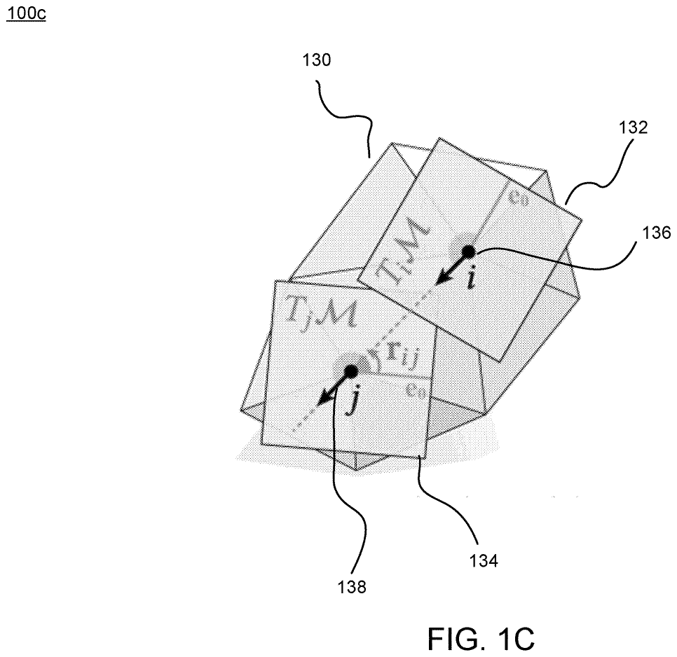

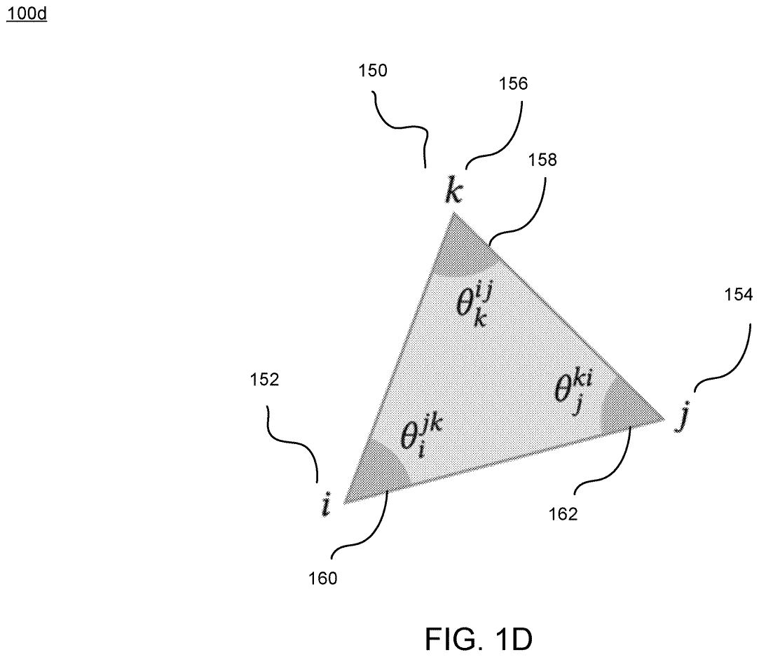

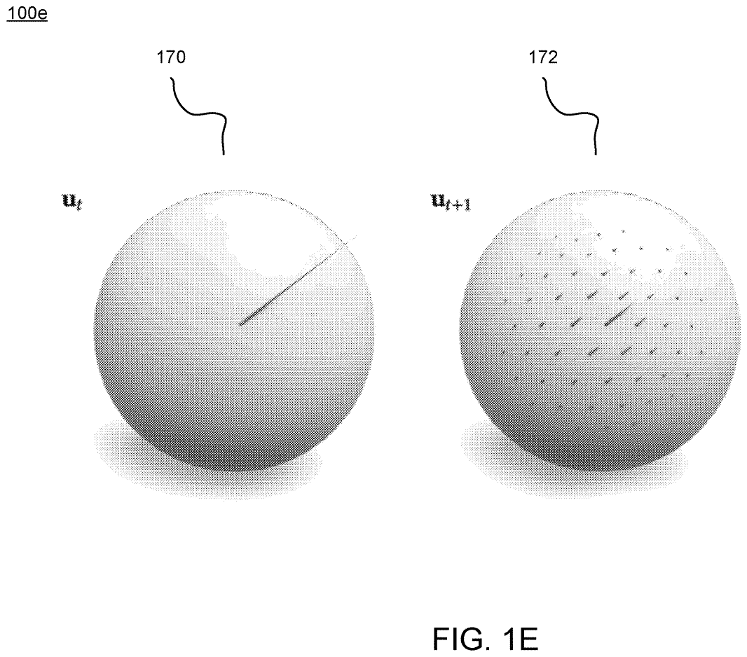

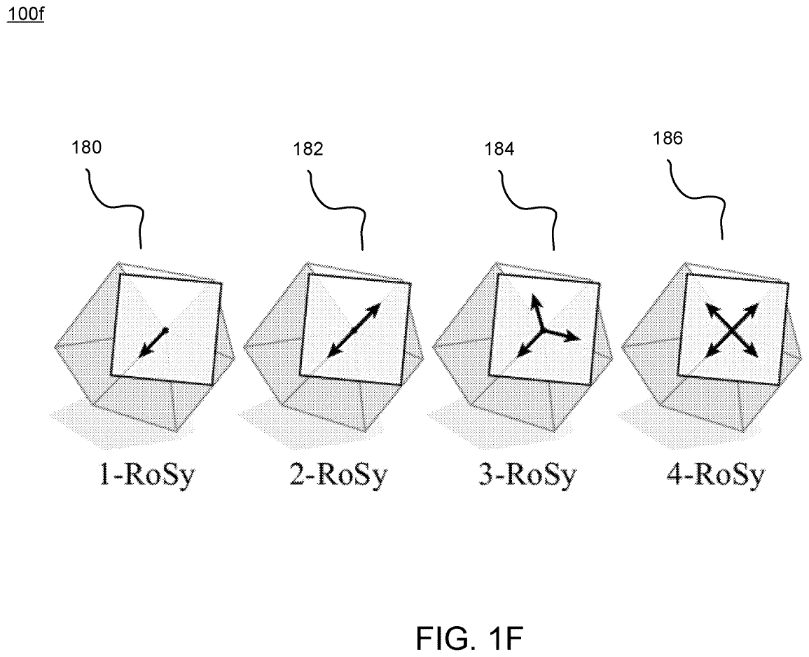

Various implementations define an architecture, based on the notion of tangent vectors, parallel transport, and the heat equation. These concepts are described in greater detail in respect to FIGS. 1A-1F.

Various implementations provide a neural network architecture to process tangent vector fields defined on 2-manifolds embedded in [symbol] ³. An aspect of techniques is to maintain vector-valued features throughout the neural network architecture, and to utilize a trainable vector heat diffusion process to ensure that the architecture maintains invariances for tangent vector field processing.

The implementations relate to geometric deep learning focused on training a neural network to generate tangent vector fields defined on discrete surfaces embedded in [symbol] ³. Such surfaces can be represented as point clouds, implicit functions, or analytical functions for simple shapes, e.g., a sphere.

Unlike prior techniques that focus on training to generate vector fields defined on a volume, various implementations described herein focus on tangent vector fields defined on a triangle mesh, a widely used surface representation for computer graphics, scientific computing, and engineering applications.

Some implementations are based on concepts related to parallel transport (such that when tangent vectors get transported to a different point on the surface, they exhibit as-parallel-as-possible transport) and the heat equation (characterizing ways a vector gets diffused in space, which may be implemented with finite element discretization on a triangle mesh). Another concept is generalization to N-way rotational symmetry fields, such that the tangent vector fields are invariant under rotation of an integer multiple of 2π/N.

The vector-valued neural network for processing tangent vector fields utilizes vector-valued neurons with vector operations (e.g., parallel transport and the vector heat equation). Maintaining the vector nature of data throughout a pipeline results in an architecture that is invariant to isometries, rigid transformations, and the choice of tangent bases. The input to the network may be a set of tangent vectors defined on the vertices of a surface triangle mesh.

A vector heat network may include several blocks of trained heat diffusion used to harness local information, and vector multi-layer perceptrons (MLPs) used to increase the expressiveness of the information. The output of the pipeline may be a set of tangent vector fields defined on vertices. These output fields may be regular tangent vectors or tangent vectors with N rotational symmetry defined on a tangent plane.

The vector heat network may begin with training vector heat diffusion. For example, some implementations may start with a set of tangent vectors represented as complex numbers. However, in some implementations, the inputs may also include a set of scalars defined on vertices of a triangle mesh for a surface. The scalars may be provided in addition to or instead of the tangent vectors. Each scalar may be represented as a real part of a complex number. If the inputs are scalars, similar techniques to those used if the inputs are tangent vectors are applied. For example, multi-layer perceptrons (MLPs) may process the scalars as input and outputs of a series of diffusion blocks. The diffusion blocks may include heat diffusion blocks and additional MLPs, adapted for applying the techniques to scalars rather than tangent vectors. The diffusion blocks may also include additional aspects of the architectures used in techniques for tangent vectors, such as skip connections.

The implementations may harness information from local neighborhoods by solving the vector heat equation with implicit Euler integration, possibly using spectral acceleration to speed up the process. The spectral acceleration may include replacing solving a linear system with matrix multiplication when solving the vector heat equation. Each vector heat diffusion model includes a series of trainable time steps. Each time step diffuses an input feature into a set of diffused features.

The vector heat network may also include vector linear layers and non-linear activation functions, such as the Rectified Linear Unit. After the vector heat diffusion model, implementations may use a vector-valued MLP that includes a per-vertex linear layer, using a matrix to linearly combine complex-valued features at each vertex, followed by applying non-linearities.

The overall architecture may include one or more vector diffusion blocks. Each block includes a vector heat diffusion layer and a vector-valued MLP with hidden layers (e.g., two hidden layers, though one is the minimum number of hidden layers). Some implementations may include two extra vector MLPs to adapt to a different number of input/output channels (or dimensions).

The architecture is invariant to the choice of tangent bases because the vector heat diffusion module determines how to transport the vector as-parallel-as-possible, regardless of the choice of tangent bases. This property makes the architecture invariant to the bases. Further, the vector heat diffusion process is intrinsic. This property ensures that the architecture is also invariant to rigid transformations and to isometries of the underlying shape. These advantageous invariance properties result in a general network architecture to process tangent vector fields on manifolds while maintaining traits of the input.

The architecture possesses several advantageous invariances. These invariances arise from the fact that the operations (gradient, heat diffusion, and the per-vertex linear layer) are intrinsic, which implies that the architecture is invariant as to a way that the mesh sits in space because intrinsic operations do not depend on particular coordinate systems or parameterization. There is also invariance to rigid motion. There is also invariance to the choice of tangent bases. The techniques are also invariant to isometric deformation (isometries of the input).

The techniques also possess robustness to discretization(s). For example, this property may be achieved by implementing the vector heat diffusion module using a connection Laplacian that demonstrates robustness to different finite element discretizations. This characteristic ensures that parameters for the trained architecture are generalizable to arbitrary meshes with different connectivity between vertices.

The described techniques and model architecture have several applications. For example, the architecture may be used in quadrilateral remeshing. A triangle mesh may be used to generate input features to train a network to generate cross-field information. The cross-field information may then be transformed into a quadrilateral mesh. The network may be trained on a training dataset, with slight adaptations to the particular task to be performed.

In some implementations, a loss function (e.g., used to train the model) may include a mean squared error (MSE) function based on an output tangent vector field. Once vectors are predicted at mesh vertices, a transportation step may be performed to express the vectors on face tangent planes. Quadrilateral remeshing may be implemented using appropriate hyperparameters.

For example, quadrilateral remeshing that has well-shaped elements (close to 90 degrees on the corner of each quad) and is aligned with geometric features may be suitable for animation 3D objects, such as avatar heads or objects such as animals. Metrics such as edge directions, principal curvature directions, and the gradients of Heat Kernel Signature, Gaussian curvature, and mean curvature may be used to determine the quality of the results.

Some implementations use a neural network architecture based on vector heat diffusion to process tangent vector fields defined on manifold surfaces. Various implementations relate to techniques that are invariant to rigid transformations and the choice of tangent plane bases and are robust to different triangularizations. These properties make this network a generalizable architecture to train a model to generate tangent vector fields across surfaces.

FIG. 1A is a diagram of various aspects of tangent planes with respect to a point on a manifold 100a, in accordance with some implementations. The tangent plane Tₚ [symbol] at point p on a manifold [symbol] does not have a canonical choice of basis vectors e₀, e₁. The techniques disclosed herein for being trained to identify tangent vector fields is invariant to a choice of tangent bases.

For example, FIG. 1A illustrates three identical spheres, sphere 102, sphere 104, and sphere 106. Each sphere has a point p and illustrates a tangent plane to point p. Sphere 102 defines one set of basis vectors e₀, e₁, sphere 104 defines one set of basis vectors e₀, e₁, and sphere 106 defines one set of basis vectors e₀, e₁. All tangent planes and basis vectors are valid, and there is no canonical choice.

FIG. 1B is a diagram of various aspects of basis invariant tangent vectors 100b, in accordance with some implementations.

FIG. 1B illustrates a 2-manifold surface [symbol] 110, vector e₀ 112, e₁ 114, point p 116, vector u 118, and tangent plane Tₚ [symbol] 120, all with reference to a three-dimensional object (illustrated in darker grey shade, with a plurality of surfaces).

Given a 2-manifold surface [symbol] 110 embedded in [symbol] ³, the tangent plane Tₚ [symbol] 120 for a given point p 116, where p∈ [symbol] , is a 2D space that is orthogonal to the surface normal of [symbol] 110 at point p 116. A tangent plane Tₚ [symbol] 120 can be defined by the spanning of an arbitrary choice of two orthogonal basis vectors e₀ 112 and e₁ 114. A 2D tangent vector u 118, where u∈Tₚ [symbol] can then be expressed as a linear combination of basis vectors u=uₒe₀+u₁e₁.

For computational convenience, these tangent vectors u 118 are represented as a complex number u=u₀+iu₁∈ [symbol] of therein coefficients u₀, u₁. Note that the coefficients u₀, u₁ change, by a coordinate transformation, depending on the choice of tangent bases e₀, e₁, in order to represent the same tangent vector. Since the choice of bases is arbitrary, one invariance for tangent vector processing is to guarantee that the technique is independent of the choice of bases.

FIG. 1C is a diagram of parallel transport of tangent vectors 100c, in accordance with some implementations. FIG. 1C shows a manifold 130 overlaid with a tangent vector in Tᵢ [symbol] 132 and a tangent vector in Tⱼ [symbol] 134. Specifically, FIG. 1C shows a tangent vector from vertex i 136 and a tangent vector from vertex j 138.

An edge vector eᵢⱼ=vⱼ−vᵢ∈ [symbol] ³ between two adjacent vertices i, j with locations vᵢ, vⱼ∈ [symbol] ³ can be expressed as a tangent vector in Tᵢ [symbol] 132 and Tⱼ [symbol] 34 via the logarithmic map (sometimes alternately referred to as the exponential map). A simple way to compute the logarithmic map is to represent the edge vector eᵢⱼ in the polar coordinate (Iᵢⱼ, θⱼ) of the tangent plane Tᵢ [symbol] 132, where Iᵢⱼ=∥eᵢⱼ∥ is the edge length and θⱼ∈[0,2π) denotes the angular coordinate (normalized to 2π) of this edge vector from a (arbitrarily chosen) tangent basis e₀.

As the edge vector eᵢⱼ exists in both tangent planes Tᵢ [symbol] and Tⱼ [symbol] , the angular difference between Tᵢ [symbol] and Tⱼ [symbol] can be computed and the coordinate transform rᵢⱼ∈ [symbol] (a rotation) be obtained in order to make sure that logᵢ (eᵢⱼ)∈Tᵢ [symbol] is mapped to logⱼ (eᵢⱼ) ∈Tⱼ [symbol] . Transporting tangent vectors from Tᵢ [symbol] to Tⱼ [symbol] following the computed rotation rᵢⱼ leads to as-parallel-as-possible (APAP) transport, or parallel transport.

Note that the angle of these vectors varies as the curved surface is traversed. The length remains unchanged. This property motivates constructing a network that can preserve these disentangled vector properties.

FIG. 1D is a diagram of various aspects of a vector heat diffusion process 100d, in accordance with some implementations.

FIG. 1D shows a triangle 150. Triangle 150 is used in the diffusion and discretization. Triangle 150 includes vertex i 152, vertex j 154, and vertex k 156, as well as angle

$${θ}_{k}^{ij}$$

158, angle

$${θ}_{i}^{jk}$$

160, and angle

$${θ}_{j}^{ki}$$

162.

The heat equation on a tangent vector field u: [symbol] → [symbol] can be written as Equation 1:

$$\frac{d}{dt} u = {Δ}_{c} u$$

where Δ_{c} is the connection Laplacian. This vector heat equation characterizes ways a vector gets diffused in space.

Diffusing a single vector heat source smears the vector heat source out to a corresponding neighborhood with smaller magnitude while maintaining the direction to be as-parallel-as-possible. This is different from classic heat diffusion where no notion of parallel transport is captured and can cause inconsistent vector directions if scalar heat diffusion is applied naively to each vector field channel independently.

In defining the vector heat equation on a triangle mesh, the main component is a discrete connection Laplacian L_{C}∈C^{n×n}. The discrete connection Laplacian is an n×n complex-valued matrix, where n denotes the number of vertices in the mesh. One way to build L_{C} is by accumulating a 3-by-3 complex matrix using Equation 2:

$$- \frac{1}{2} [ \begin{matrix}{c}_{j} + {c}_{k} & - {c}_{k} {r}_{ij} & - {c}_{j} {r}_{ik} \\ {c}_{k} + {r}_{ji} & {c}_{k} + {c}_{i} & - {c}_{i} {r}_{jk} \\ - {c}_{j} + {r}_{ki} & - {c}_{i} {r}_{kj} & {c}_{i} + {c}_{j}\end{matrix} ]$$

associating to each triangle ijk into the corresponding entries defined by the vertex index. The equations

$${c}_{i} = cot {θ}_{i}^{jk} , {c}_{j} = cot {θ}_{j}^{kj} , {c}_{k} = cot {θ}_{k}^{ij} ,$$

are used to shorten the expression, and rᵢⱼ ∈ [symbol] (so as rⱼₖ, rₖᵢ) to denote the 2D rotation (represented as a unit complex number) that parallel transports a tangent vector from the tangent plane Tᵢ [symbol] at vertex i to the tangent plane Tⱼ [symbol] at vertex j.

FIG. 1E is a diagram of discretization(s) in a vector heat diffusion process 100e, in accordance with some implementations. As the forward Euler method is well-known to be unstable under large time steps, the numerical solution to the vector heat equation is computed using the implicit Euler method.

FIG. 1E shows an initial sphere 170 associated with an initial tangent vector field and a diffused sphere 172 associated with a diffused tangent vector field.

Specifically, a single step of the diffusion is defined as Equation 3: uₜ₊₁=(M+sL_{c})⁻¹Muₜ where s denotes the time-step size, M∈ [symbol] ^{n×n} diagonal matrix whose entries are complex-valued, with vertex area as the real component, and zero imaginary component. Equation 3 diffuses a vector into smaller magnitudes, and as-parallel-as-possible (APAP) orientations.

The vector heat diffusion process presented in Equation 3 smears out a tangent vector field uₜ associated with initial sphere 170 to corresponding neighbors to obtain another tangent vector field uₜ₊₁ associated with diffused sphere 172. FIG. 1E illustrates that a tangent vector field uₜ associated with initial sphere 170 is the initial vector field, and tangent vector field uₜ₊₁ associated with diffused sphere 172 includes a plurality of diffused vectors having smaller magnitudes and as-parallel-as possible orientations.

FIG. 1F is a diagram of tangent vectors that are N-way rotationally symmetric 100f, in accordance with some implementations. FIG. 1F illustrates examples of 1-RoSy 180, 2-RoSy 182, 3-RoSy 184, and 4-RoSy 186.

In several applications, it may be helpful to identify a N-way rotational symmetry fields that are invariant under rotation of an integer multiple of

$$\frac{2 π}{N} .$$

For instance, one of the applications in quadrilateral meshing outputs 4-Rosy fields in order to mesh a surface with the cross pattern on most vertices.

The generalization to N-Rosy fields is straightforward given the complex number representation. Since multiplication with (unit) complex numbers represents rotations, raising a complex number to the power of N reduces the space of unique angles down to

$$\frac{2 π}{N} ,$$

thus factoring out the N-way rotational symmetry. To measure the difference between e.g., 4-Rosy fields, the difference between u⁴ can be measured.

Each of the examples illustrated in FIG. 1F corresponds to a different value of N (for N-way rotational symmetry). For example, 1-RoSy 180 (N=1) refers to the usual 3D tangent vector, 2-RoSy 182 (N=2) refers to a straight line, and 4-RoSy 186 (N=4) refers to a cross field where RoSy stands for rotational symmetry. These are non-limiting examples and other positive integer values for N are possible, having different meanings.

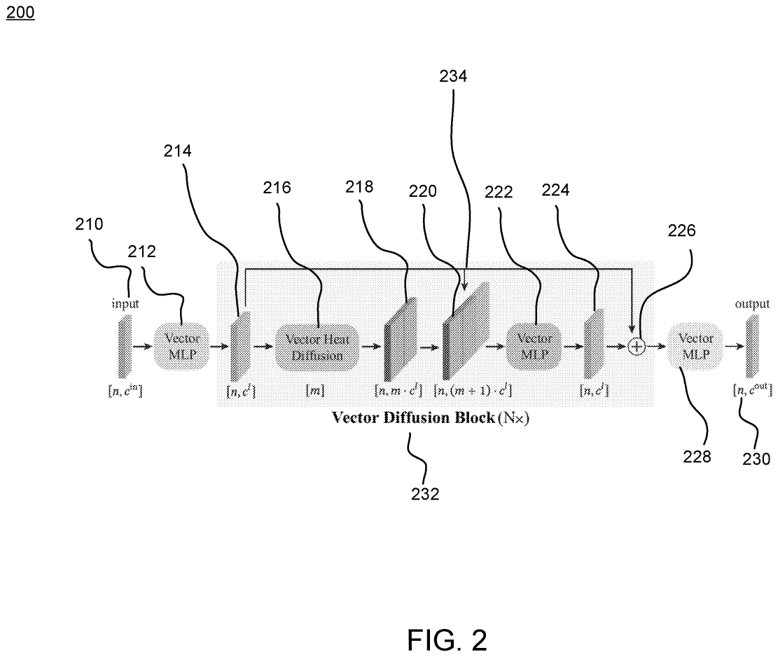

FIG. 2 is a diagram illustrating a vector heat network 200, in accordance with some implementations. The vector heat network 200 is provided a set of input vectors 210 having dimensions [n, cⁱⁿ] (where there are n vectors represented as complex numbers, each including cⁱⁿ channels (or dimensions). Input vectors 210 may be provided as input to initial vector multi-layer perceptron (MLP) 212.

Initial vector MLP 212 transforms the dimensionality of vectors in input vectors 210 to generate a set of transformed vectors 214 having dimension [n, c^{l}]. n denotes the number of vertices and c^{l} denotes the number of tangent vector fields. Initial vector MLP 212 generates the set of transformed vectors 214 having dimensions [n, c^{l}] which are provided as input to a vector diffusion block 232 (of which there may be N instances, where N can be one or a larger integer).

Each vector diffusion block 232 is initiated with the set of transformed vectors 214 having dimensions [n, c^{l}]. The set of transformed vectors 214 having dimensions [n, c^{l}] are subjected to a vector heat diffusion module 216 for m timesteps, where the timesteps may be trainable. This yields a set of vectors 218 having dimensions [n, m·c^{l}]. The set of vectors 218 having dimensions [n, m·c^{l}] are supplemented by the set of transformed vectors 214 having dimensions [n, c^{l}] using a skip connection 234, resulting in another set of vectors 220 having dimensions [n, (m+1)·c^{l}]. The skip connection 234 is used to make sure that as more layers are stacked into the network, the performance can only improve, avoiding possibly getting worse.

This set of vectors 220 having dimensions [n, (m+1)·c^{l}] are provided to vector MLP 222, where vector MLP 222 takes the set of vectors 220 having dimensions [n, (m+1)·c^{l}] and outputs an additional set of vectors 224 having dimensions [n, c^{l}] (based on successive complex linearization and vector activation). The set of transformed vectors 214 having dimensions [n, c^{l}] and the additional set of vectors 224 having dimensions [n, c^{l}] may be combined using a summation function at 226.

The vector diffusion blocks 232 may be performed iteratively (with the output of a prior block fed as input to a subsequent block at 214) until a termination condition is met. As discussed herein, the termination condition may include the use of N vector diffusion blocks. The iterative process may be subject to a termination condition that determines a point to stop iterating. In some implementations, the termination condition may be determined as being met if a set number of passes of the vector diffusion blocks have occurred. In some implementations, the termination condition may be determined as being met if a loss function satisfies a condition. In some implementations, the termination condition may be determined as being met if training is no longer improving performance at a rate exceeding a threshold.

N of such vector diffusion blocks 232 are utilized, after which a final output is provided to second vector MLP 228, which changes the dimensionality of the final output to a final dimensionality as output 230. For example, output 230 may be a set of vectors having dimensions [n, c^{out}]. The diffusion blocks may run for N iterations. If some final blocks are not useful for improving the result, the machine learning model may utilize a “skipped connection” to make, for instance, the result after N blocks be the same as the result after running N−1 blocks.

The vector diffusion blocks 232 start with a set of tangent vectors u∈ [symbol] ^{n×c}^{^{l}} (represented as complex numbers), where n denotes the number of vertices and c^{l} denotes the number of tangent vector fields. There may be a transformation from [symbol] ^{n×c}^{ⁱⁿ} to [symbol] ^{n×c}^{^{l}}. Various implementations utilize information from local neighborhoods by solving the vector heat equation with the implicit Euler integration. Some implementations utilize spectral acceleration techniques to speed up the process of solving the vector heat equation. This can be computationally more efficient than implicit Euler integration which requires computationally expensive operations of solving a linear system.

The spectral acceleration techniques may include replacing solving a linear system with matrix multiplication when solving the vector heat equation. Specifically, given the solution of the generalized eigenvalue problem of the discrete connection Laplacian L_{c}, where Equation 4 specifies: L_{c}Φ=MΦΣ, where Φ={Φᵢ}∈ [symbol] ^{n×k} is the stack of k eigenvectors with the lowest frequencies and Σ=diag(λᵢ)∈ [symbol] ^{k×k} is a diagonal matrix with corresponding eigenvalues.

M denotes the mass matrix of vertex areas such that Φᵢ^{T}M [symbol] ᵢ=1. k is a user-defined number to specify a quantity of eigenvalues/eigenvectors that are in use. Then the vector diffusion process can be approximated with Equation 5:

$${u}_{t + 1} = Φ [ \begin{matrix}{e}^{- {λ}_{1} s} \\ {e}^{- {λ}_{2} s} \\ : \\ \dot{{e}^{- {λ}_{k} s}}\end{matrix} ] ⊙ ( {Φ}^{⊤} {Mu}_{t} )$$

where ⊙ denotes element-wise multiplication. Such a spectral acceleration technique replaces linear solves with matrix multiplications and is significantly faster for small values of k. In some implementations, k=128 is the set value of k. This is a non-limiting example, and k may take on other user-set values. Alternatively, k may be set automatically or suggested using a heuristic.

In some implementations, the time-step size s is treated as a trainable parameter. The network is trained whether to diffuse the vectors over a small or large local neighborhood. Specifically, each vector heat diffusion module includes m trainable time steps. Each time step sᵢ diffuses the input feature X^{l}∈ [symbol] ^{n×c}^{^{l}} at layer l into a set of diffused features

$${Y}_{i}^{l} ∈ {ℂ}^{n \times {c}^{l}}$$

via equation 5. A collection of m time steps [s₁, . . . , sₘ] turns an input feature X^{l} with size n×c^{l} into a set of diffused features

$${Y}^{l} = [ {Y}_{1}^{l} , … , {Y}_{m}^{l} ]$$

with size n×mc^{l}.

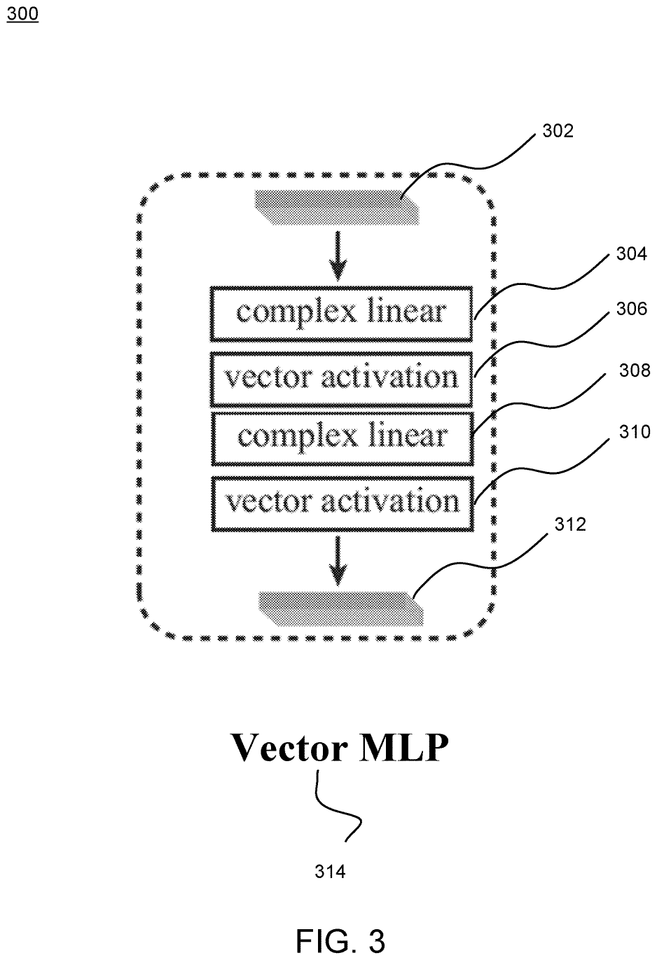

The diffused features are provided for additional processing using a vector-valued MLP. Additional details of such processing are presented in the discussion of FIG. 3, below.

The overall architecture includes several vector diffusion blocks. Each block contains a vector heat diffusion later and a vector-valued MLP. The vector-valued MLP may have at least two hidden layers. Implementations also have two additional vector MLPs to adapt to a different number of input/output channels (or dimensions).

The architecture is invariant to the number of tangent bases because the vector heat diffusion module has parallel transport incorporated, making the diffusion module invariant to the bases. Furthermore, the vector heat diffusion process is intrinsic. This ensures that the architecture is also invariant to rigid transformations and isometries of the underlying shape. These useful invariances result in a general network architecture for processing tangent vector fields on manifolds.

FIG. 3 is a diagram illustrating a vector multi-layer perceptron (MLP) 300, in accordance with some implementations. The vector MLP 300 includes input 302, which is the output of the vector heat diffusion module 216 of FIG. 2. The vector MLP itself 314 (as shown in FIG. 3) includes a set of two successive layers, each layer itself including two components. For example, input 302 is provided to a first complex linear layer 304 followed by a first vector activation layer 306. The result of these two layers is provided to a second complex linear layer 308 followed by a second vector activation layer 310. The vector MLP 314 outputs output 312.

For example, to determine the first complex linear layer 304, after the vector heat diffusion module, some implementations use a vector-valued MLP that includes a per-vertex linear layer according to Equation 6: Z^{l}=Y^{l}W^{l} where W^{l}∈ [symbol] ^{mc}^{^{l}}^{×c}^{^{l+1}} is a matrix of size mc^{l} by c^{l+1} that linearly combines the complex-valued features at each vertex into Z^{l}∈ [symbol] ^{n×c}^{^{l+1}}.

Then, to obtain the first vector activation layer 306, techniques may apply non-linearities σ (e.g., rectified linear unit (ReLU) on the magnitude of each complex feature as, according to Equation 7:

$${X}_{ij}^{l + 1} = σ ( ‖ {Z}_{ij}^{l} ‖ - {b}_{j}^{l} ) \cdot \frac{{Z}_{ij}^{l}}{‖ {Z}_{ij}^{l} ‖}$$

where

$${Z}_{ij}^{l}$$

denotes the entry corresponding to the ith row and the jth column in Z and

$${b}_{j}^{l} ∈ ℝ$$

is a bias term for each channel added to the feature norm. In some implementations, the Rectified Linear Unit (ReLU) activation is used. For the ReLU, the complex feature norm

$$‖ {Z}_{ij}^{l} ‖$$

is smaller than the bias

$${b}_{j}^{l} ,$$

the complex feature is set to 0, otherwise the complex feature is unchanged in the output X^{l+1}.

Similar operations are repeated for the second complex linear layer 308 and the second vector activation layer 310. After the operations are repeated, the vector MLP 314 outputs output 312. FIG. 3 illustrates a vector MLP where there are two sets of complex linear/vector pair layers. In some implementations, the vector MLP may include more or fewer sets of complex linear/vector pair layers. For example, it is possible to have one or more hidden layers. Some implementations use two layers simply because various tests show that two layers perform well.

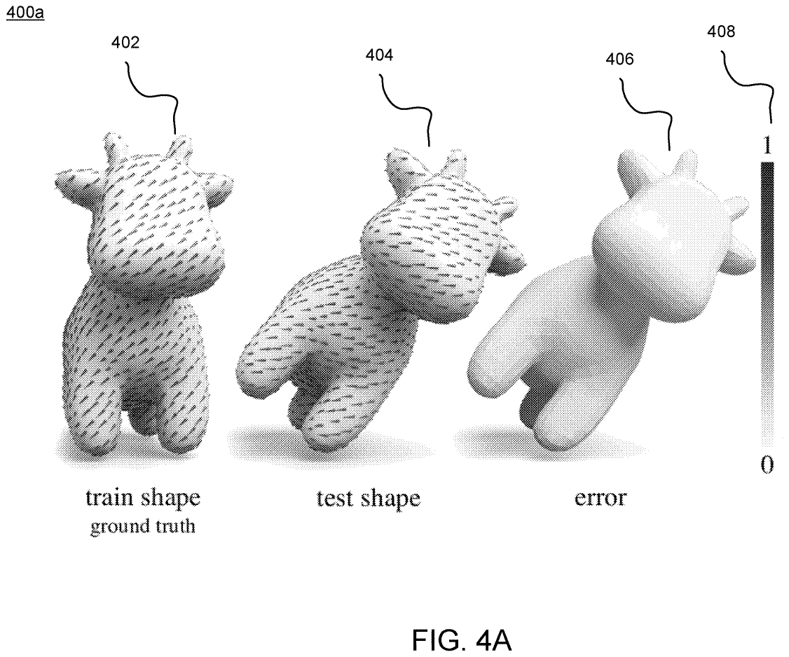

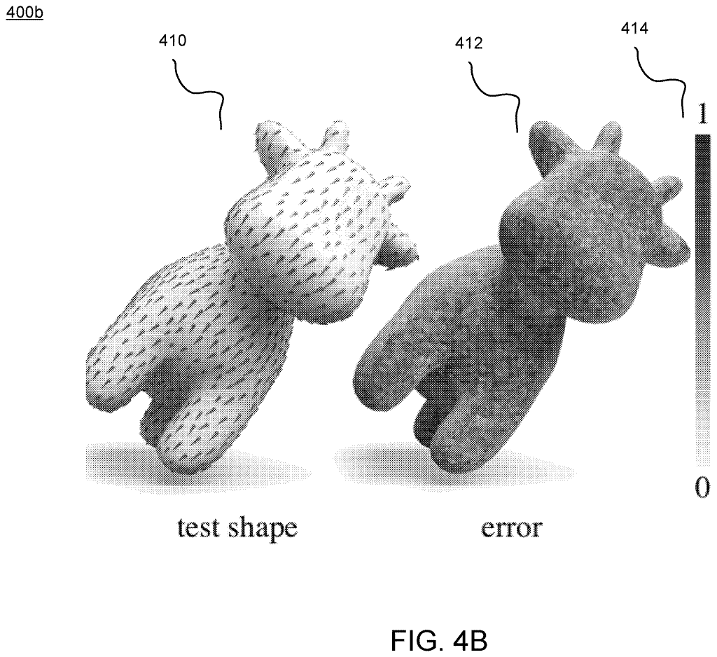

FIG. 4A illustrates an architecture that is invariant to rigid transformation 400a, in accordance with some implementations.

FIG. 4A illustrates a groundtruth training shape 402. FIG. 4A also illustrates a test shape 404 generated using techniques discussed herein and an error visualization 406 illustrating error resulting from using the techniques discussed herein. Error scale 408 illustrates, using grayscale, an amount of error that is associated with a grayscale value in error visualization 406. The pointed shapes in FIG. 4A are the visualizations of the tangent vector field. Each “line” on the surface is a predicted tangent vectors. The direction of the predicted tangent vectors may be visualized as a line, as shown.

FIG. 4A illustrates that much of the error presented in error visualization 406 associated with test shape 404 is small. For example, error scale 408 shows that darker regions in the error visualization 406 include a greater amount of error, and lighter regions in the error visualization 406 include a smaller amount of error. Error visualization 406 includes may regions that are light and only a few regions that are darker. Based on the overall light shading of error visualization 406, in consideration of error scale 408, it shows that test shape 404 models groundtruth training shape 402 well despite a rigid transformation (i.e., a rotation).

The architecture possesses several invariances that are highlighted and empirically validated herein, distinguishing the techniques from the scalar-valued approach. These invariances arise from the fact that such operations (gradient, heat diffusion, and the per-vertex linear layer) are intrinsic, which implies that the architecture is invariant to a way that the mesh sits in the space. Here, intrinsic means that the operations do not rely on specific coordinate systems or parameterizations to be calculated.

If rigid motion invariant input features are used, then the technique is invariant to rigid transformations of the underlying shape. The overall architecture is invariant to rigid transformation. A model trained on a mesh at one orientation generalizes to a rigidly transformed counterpart, outputting a tangent vector field with no error or minimal error. This result differs from the results of an alternative technique, illustrated in FIG. 4B, which outputs a different vector field with high error when performing rigid transformations.

FIG. 4B illustrates an alternative architecture that outputs a different vector field with high error 400b. For example, FIG. 4B illustrates an alternative test shape 410 (based on groundtruth training shape 402) and a corresponding error visualization 412 for the alternative test shape 410. FIG. 4B also shows error scale 414 illustrating an amount of error.

As with error scale 408, error scale 414 shows that darker regions in the error visualization 412 include a greater amount of error, and lighter regions in the error visualization 412 include a smaller amount of error. By contrast with test shape 404 from FIG. 4A, alternative test shape 410 includes significant amounts of error. Error visualization 412 is dark gray throughout, including some nearly black regions. Error visualization 412 indicates that alternative test shape 410 includes significant errors as compared to test shape 404 as generated using the current techniques. FIG. 4B presents visualizations of tangent vectors, similar to what is shown in FIG. 1E.

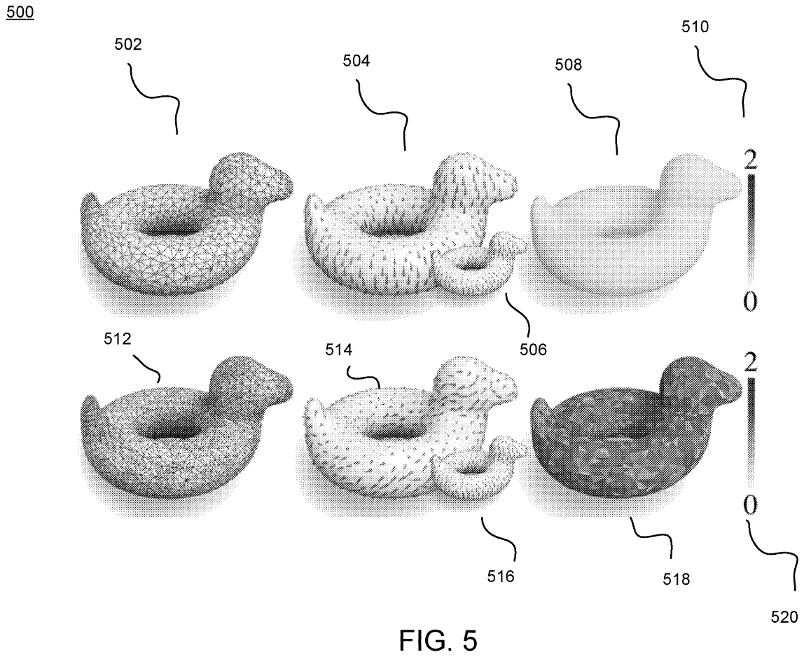

FIG. 5 illustrates a technique that is invariant to a choice of tangent bases 500, in accordance with some implementations. Some implementations leverage the characteristic that parallel transport has already factored out the influence of choice of tangent bases, which is incorporated into the connection Laplacian.

This property makes the architecture invariant to the choice of tangent bases. The techniques are invariant to choice of tangent bases. Given a model trained on the default bases, where the arrow indicates a direction of the vector e₀, the techniques produce the same result as a groundtruth result, even when the model is evaluated under different choice of bases, that outputs a different result with high error.

For example, FIG. 5 illustrates meshes for training and testing bases in present techniques 502 and meshes for training and testing bases in alternative techniques 512. FIG. 5 also illustrates output vector fields 504 and groundtruth vector fields 506, as well as an error visualization 508 and an error scale 510. Based on error scale 510 (where darker shading indicates more error), it can readily be seen that present techniques provide a relatively low amount of error when generating output vector fields 504 as compared to groundtruth vector fields 506. In FIG. 5, error visualization 508 generally includes light regions, indicating that the error is low.

FIG. 5 also illustrates meshes for training and testing bases in present techniques 502 and meshes for training and testing bases in alternative techniques 512. FIG. 5 also illustrates output vector fields 514 and groundtruth vector fields 516, as well as an error visualization 518 and an error scale 520. Based on error scale 520 (where darker shading indicates more error), it can readily be observed that alternative techniques provide a relatively high amount of error when generating output vector fields 514 as compared to groundtruth vector fields 516. In FIG. 5, error visualization 518 generally includes dark regions, indicating that the error is high.

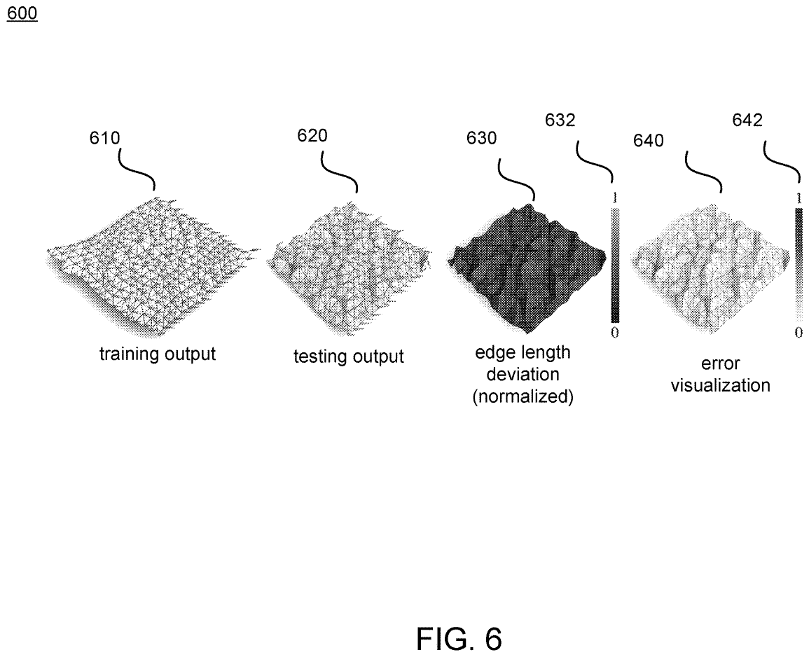

FIG. 6 illustrates a technique that is invariant to isometric deformation 600, in accordance with some implementations. The technique is invariant to isometric deformation (isometries) of the input due to the intrinsic construction of the method. The technique is invariant to isometric deformation. Some implementations may be trained on a flat paper and evaluated on a corresponding crumpled counterpart. Since these two meshes are nearly isometric, the technique produces consistently high-quality results.

For example, FIG. 6 illustrates training output 610, testing output 620, edge length deviation 630 (normalized) and error visualization 640. Training output 610 illustrates a flat piece of paper and testing output 620 illustrates a corresponding crumpled counterpart. Edge length deviation 630 is illustrated, using error scale 632, to have a low error value. This low error value is illustrated in that error scale 632 illustrates lower values as darker and greater values as lighter.

Edge length deviation 630 illustrates many dark regions. The presence of dark regions in edge length deviation 630 indicates good performance, in that error scale 632 indicates Error visualization 640 is illustrated, using error scale 642, to also have a low error value. Error visualization 640 includes many light regions, which indicates a low amount of error according to error scale 642.

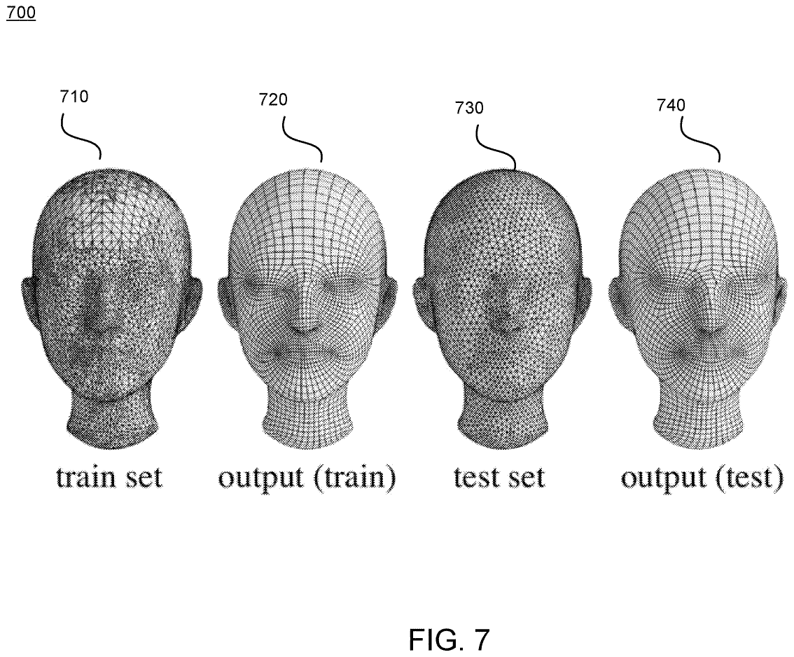

FIG. 7 illustrates a technique that exploits the benefit of a spectral technique and gains robustness to different discretization(s) 700, in accordance with some implementations. FIG. 7 illustrates a training set 710, a training set output 720, a test set 730, and a test set output 740. The model may be trained on training set 710 and generalizes to test set 730. Because of this generalization, training set output 720 may be consistent with test set output 740, such as when producing quad meshing results.

In some implementations, an aspect for message passing relies on the vector heat diffusion with the connection Laplacian. Other techniques may be trained to identify the connection Laplacian for a graph. Using the present techniques, the connection Laplacian in the set-up is deterministic with respect to the underlying shape, with connections determined by the parallel transport.

This approach ensures that the parameters identified from the training are generalizable to meshes with different connectivity. This property of generalizable parameters is relevant to tangent vector field processing because the choice of tangent bases is arbitrary. It is possible to find an infinite number of valid tangent bases e₀, e₁ that are orthogonal to the normal vector.

On a single vertex, there is already an infinite number of choices for tangent bases. The total combinations of basis choices also grows exponentially with the number of vertices in the mesh. This aspect implies that incorporating the property of basis invariance is appropriate because using techniques with data augmentation is intractable due to the infinite number of basis combinations.

Some implementations exploit the benefit of the spectral techniques and gain robustness to different discretization(s). Trained on one triangulation, some implementations may generalize to a different one, producing consistent output.

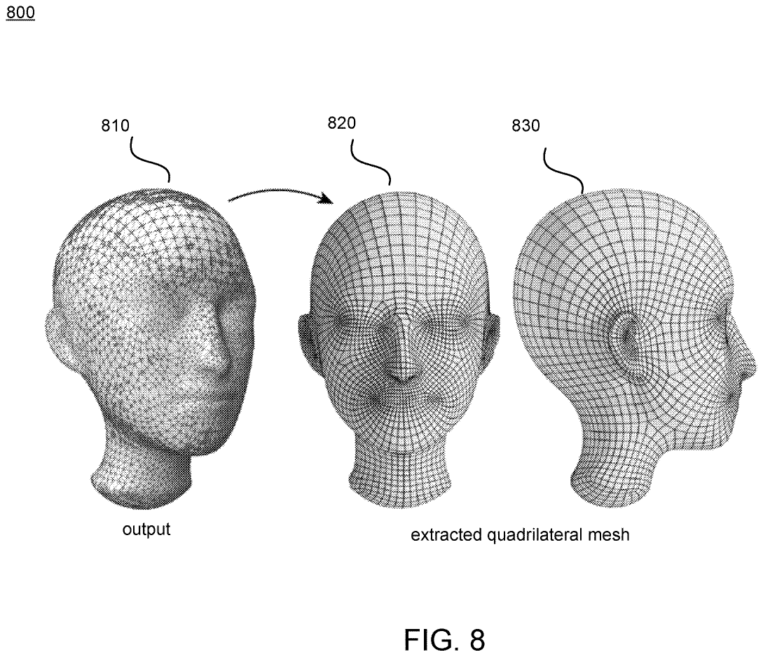

FIG. 8 illustrates a technique that, after obtaining the output cross field, uses available quad mesh extraction techniques to obtain a quadrilateral mesh with edges aligned with the predicted cross field 800, in accordance with some implementations.

To demonstrate the effectiveness of techniques, some implementations are evaluated on the task of quadrilateral remeshing. Given a triangle mesh [symbol] , some implementations use the per-channel gradient of the first cⁱⁿ (e.g., the first 15 channels, in some example implementations) of the Heat Kernel Signature (HKS) as input features to the network, given cⁱⁿ vector-valued features per vertex. A heat kernel signature is a feature descriptor for use in deformable shape analysis and belongs to the group of spectral shape analysis methods. For each point in the shape, HKS defines its feature vector representing the point's local and global geometric properties. The output in such an example is a 4-RoSy (where RoSy refers to Rotational Symmetry) cross field defined on each vertex. Implementations may then interpolate the per-vertex cross field onto faces, followed by available techniques to turn the per-face cross field into a quadrilateral mesh.

After obtaining the output cross field by the network, some implementations may use available quad mesh extraction techniques to obtain a quadrilateral mesh with edges aligned with the predicted cross field.

In some implementations, the network may be trained on a dataset generated from the workflow described in an alternative technique, with two modifications. First, as an alternative to using a pre-existing dataset of scans of human bodies in motion as used by the alternative technique, some implementations assemble a custom library of artist-created template avatar heads, around which the implementations wrap the head topology. For example, the head topology may be provided using a Skinned Multi-Person Linear (SMPL) model.

Second, for each of the template meshes, some implementations may create 100-1,000 augmentations/variations, using a custom tool for deforming faces. For example, the deforming may be based upon normal-driven As-Rigid-As-Possible (ARAP) deformation. This aspect of techniques expands the training data distribution away from the parametric SMPL model. The training dataset may include, according to some implementations, about 1100 triangle meshes with associated ground truth vector fields.

Since the output is a 4-Rosy field, the loss function is defined as the mean squared error (MSE) on the output tangent vector field u⁴ raised to the power of 4. In addition to measuring errors on the directions, it is also useful to measure errors on the magnitude of the cross field (smaller crosses lead to smaller polygon). Combining the two leads to the following loss function, Equation 8:

$$L ( u , \hat{u} ) = {\sum }_{i = 1}^{N} \frac{{M}_{ii}}{A} [ \vert \frac{‖ {u}_{i} ‖ - ‖ \text{?} ‖}{‖ {u}_{i} ‖} \vert + ( 1 - \frac{{u}_{i}^{4}}{‖ {u}_{i}^{4} ‖} \cdot \frac{{\text{?}}^{4}}{‖ {\text{?}}^{4} ‖} ) ]$$

In the loss function, the first term indicates a magnitude and the second term indicates a direction. Mᵢᵢ denotes the vertex area at vertex i, A=Tr(M) is the total area of the mesh, and uᵢ, ûᵢ ∈ [symbol] denote the output and the ground truth tangent vector fields on the vertex i, respectively. The first magnitude term simply measures the relative difference in magnitude between the output and the ground truth fields. The second direction term measures the angular difference using the cosine similarity (i.e., dot product).

FIG. 8 illustrates an output cross field 810 according to various techniques. This output cross field 810 is illustrated facing at an angle. The output cross field 810 yields an extracted quadrilateral mesh, obtained using various quad mesh extraction techniques. The extracted quadrilateral mesh is illustrated from a front view 820 and a side view 830. The extracted quadrilateral mesh has edges, illustrated from a front view 820 and a side view 830, that has edges aligned with the predicted cross field.

The model predicts vectors at mesh vertices. In order to directly leverage existing techniques for field-guided quadrilateral remeshing, the vectors are to be expressed on the face tangent planes. Naïvely averaging the three vector predictions from a given face's three incident vertices does not produce a correct result. The vectors are expressed with respect to the individual vector tangent planes, so the vectors cannot be averaged directly. Techniques therefore account for the parallel transport from each of the vertex tangent planes to the face tangent plane. Once the three vectors are in a shared frame, then techniques may simply average the values.

To transport a vector from a corresponding tangent plane Tᵢ [symbol] at a vertex vᵢ to the tangent plane Tᵢⱼₖ [symbol] at face fᵢⱼₖ, an edge is chosen that is incident to both elements (e.g., edge eᵢⱼ or eᵢₖ). The chosen edge can be expressed in terms of an angular rotation from the local basis in both the vertex Tᵢ [symbol] and face tangent planes Tᵢⱼₖ [symbol] . The angular difference is leveraged to transport a vector from a vertex to a face tangent plane.

This transport can be constructed as an operator in a pre-processing step, as the transport depends on the mesh. Once the angular differences are computed, the angular differences may be used to transport any vectors from vertices to faces. Let this matrix be T_{angle} ∈ [symbol] ^{F×3} where each row corresponds to a face, and each of the three values corresponds to the transition angle (in radians) used to transport a vector from the incident vertex at that index, to the face.

Then, the complex matrix operator is assembled according to Equation 9: T=e^{iT}^{_{angle}} To compute the transported, averaged result per face, according to Equation 10:

$${\hat{u}}_{f} = \frac{1}{3} \sum T ⊙ {\hat{u}}_{f} [ F ]$$

where the [·] represents an indexed selection from the per-vertex predictions based on vertex indices from the face matrix F, and the sum Σ(·) denotes a per-face addition along the last dimension of the product ΣT⊙û_{f}[F].

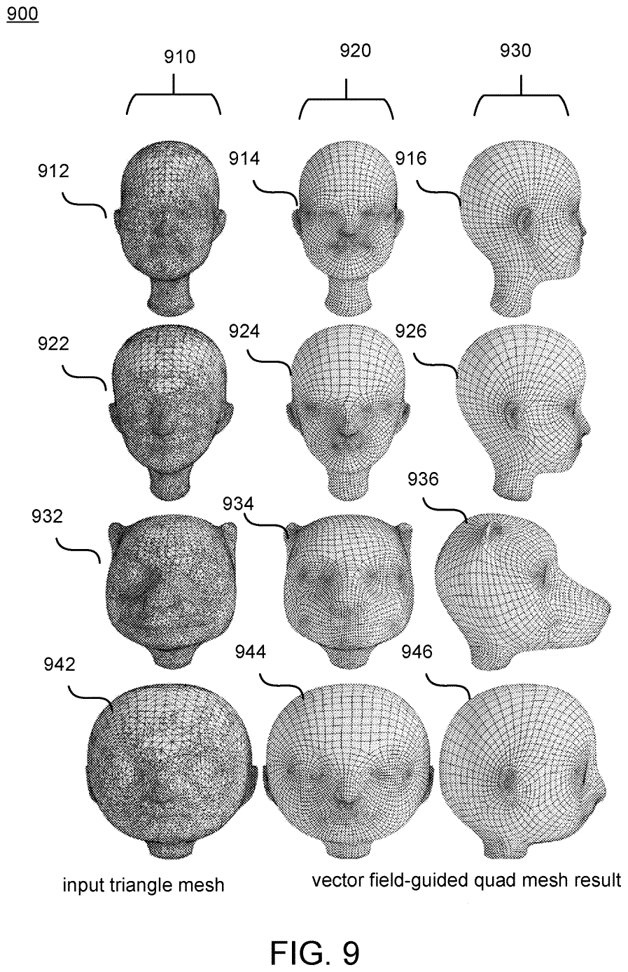

FIG. 9 illustrates vector-field-guided quadrilateral meshing results of various character heads from a test dataset 900, in accordance with some implementations. For example, FIG. 9 illustrates four input triangle meshes 910, including input triangle mesh 912, input triangle mesh 922, input triangle mesh 932, and input triangle mesh 942.

Each input triangle mesh corresponds to vector field-guided quad mesh results, including front-facing vector field-guided quad mesh results 920 and side-facing vector field-guided quad mesh results 930. For example, input triangle mesh 912 corresponds to front-facing vector field-guided quad mesh result 914 and corresponds to side-facing vector field-guided quad mesh result 916.

Input triangle mesh 922 corresponds to front-facing vector field-guided quad mesh result 924 and corresponds to side-facing vector field-guided quad mesh result 926. Input triangle mesh 932 corresponds to front-facing vector field-guided quad mesh result 934 and corresponds to side-facing vector field-guided quad mesh result 936. Input triangle mesh 942 corresponds to front-facing vector field-guided quad mesh result 944 and corresponds to side-facing vector field-guided quad mesh result 946.

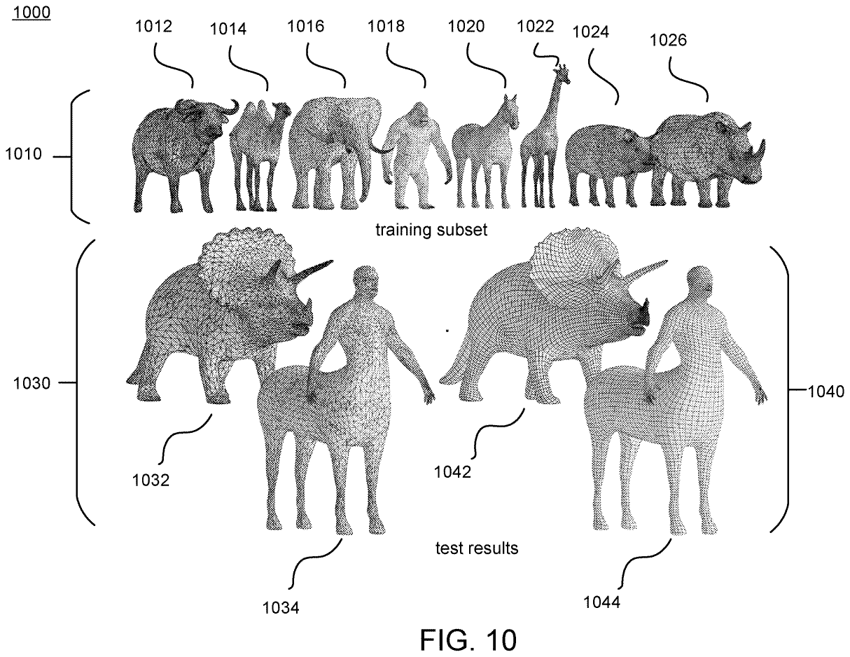

FIG. 10 illustrates a training subset and test results that illustrate ways trained vector-field-guided quadrilateral remeshing can generalize to other datasets and classes of objects 1000, in accordance with some implementations. FIG. 10 illustrates a training subset 1010. Training subset 1010 includes an assortment of meshes on which a model may be trained. For example, training subset illustrates a mesh of a bull 1012, a mesh of a camel 1014, a mesh of an elephant 1016, a mesh of a gorilla 1018, a mesh of a horse 1020, a mesh of a giraffe 1022, a mesh of a pig 1024, and a mesh of rhinoceros 1026.

FIG. 10 also illustrates test results. The test results include input triangle meshes 1030, including a triangle mesh of a triceratops 1032 and a triangle mesh of a centaur 1034. The test results also generate quadrilateral meshes 1040, including a quadrilateral mesh of the triceratops 1042 and a quadrilateral mesh of the centaur 1044.

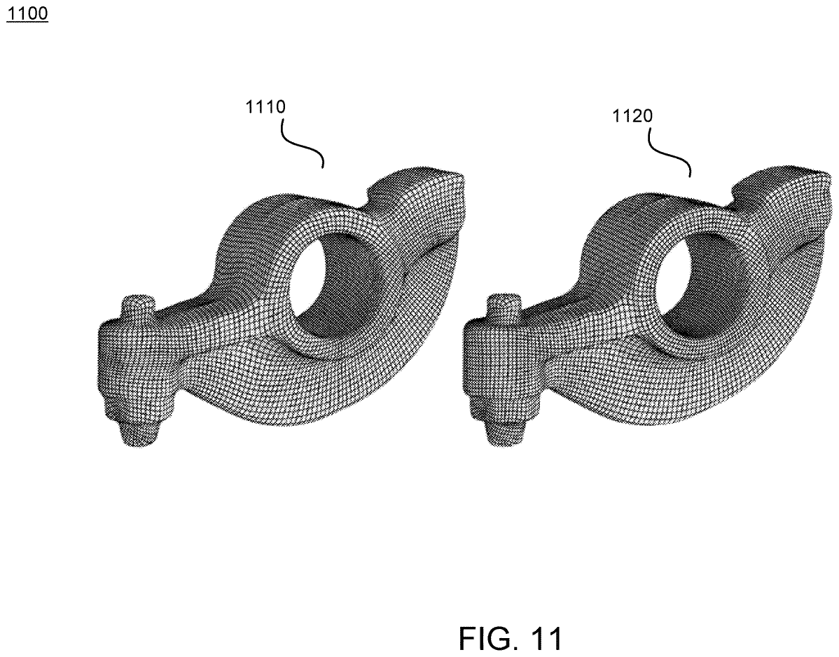

FIG. 11 illustrates results of an optimization-based quad meshing technique and using present techniques to faithfully reproduce the result 1100, in accordance with some implementations. For example, FIG. 11 illustrates using an optimization-based quad meshing technique to produce initial result 1110.

The optimization-based quad meshing technique that produces initial result 1110 may be used to supervise the present techniques. The present techniques impose no restrictions on the category of the shape on which vector fields may be trained, as demonstrated by successful generalization to various families of shapes in various examples. FIG. 11 illustrates use of the present techniques to produce results 1120, illustrating that the present techniques provide similar results to initial result 1110 produced by an optimization-based quad meshing technique.

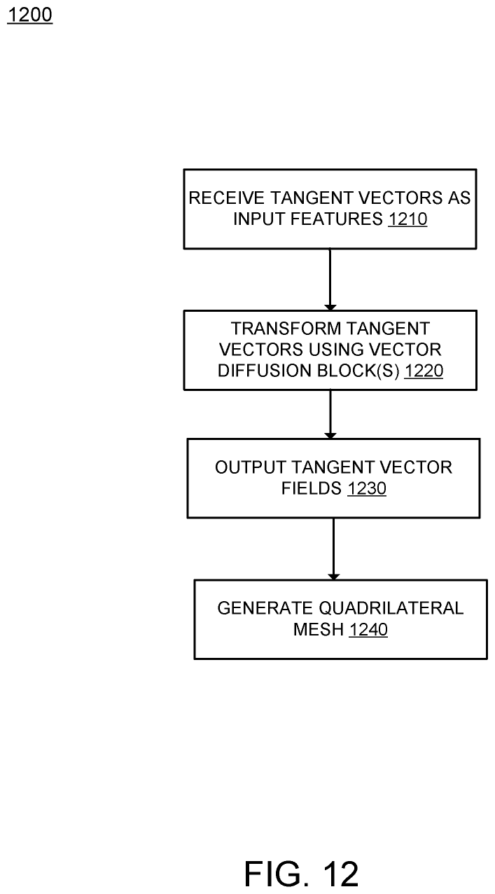

FIG. 12 is a flowchart illustrating a method 1200 to generate tangent vector field from vectors, in accordance with some implementations. FIG. 12 may begin at block 1210.

At block 1210, tangent vectors are received as input features to a neural network. The neural network used is a vector-valued neural network for processing tangent vector fields utilizes vector-valued neurons with vector operations (e.g., parallel transport and the vector heat equation, as discussed above). Maintaining the vector nature of the data throughout results in an architecture that is invariant to isometries, rigid transformations, and the choice of tangent bases.

Such tangent vectors are defined on the vertices of a surface triangle mesh. These tangent vectors may correspond to the input vectors 210 received in FIG. 2. Also as in FIG. 2, input vectors 210 may be transformed using a vector MLP to adapt the input vectors 210 (which may have an input number of channels) into a set of transformed vectors 214 having a number of channels (or dimensions) suitable for processing by the vector diffusion blocks. Block 1210 may be followed by block 1220.

At block 1220, tangent vectors are transformed using vector diffusion block(s). Such transformation is discussed further in the discussion of vector diffusion blocks 232 in FIG. 2. Briefly summarized, the input vectors are subjected to a vector heat diffusion block, yielding a set of vectors that is combined with the input vectors using a skip connection. The vector heat diffusion block may operate over a series of m trainable time steps. Solving the vector heat equation may involve spectral acceleration that includes replacing solving a linear system with matrix multiplication when solving the vector heat equation.

This result is provided to a vector MLP that generates another set of vectors having appropriate dimensions, which is subject to a direct sum operation (i.e., element-by-element summation) with the input vectors. This processing may be performed using vector diffusion block(s) N times (where N is an integer), resulting in a diffused output. In such a vector MLP, non-linearities may be applied using a rectified linear (ReLU) function. The vector MLP may include at least two hidden layers. Block 1220 may be followed by block 1230. As discussed above, the iterative transformation of the tangent vectors may also be subject to another termination condition, such as achieving a given value of a quality metric, or a failure to improve results.

At block 1230, tangent vector fields are output. The output is a set of tangent vector fields defined on vertices. These output fields may be regular tangent vectors or tangent vectors with N rotational symmetry defined on the tangent plane.

To output the tangent vector fields, the results of block 1230 may be processed by an additional vector MLP to adapt the output vectors (which may have number of channels as used in the vector diffusion block(s)) into a number of channels (or dimensions) suitable for the output. For example, FIG. 2 illustrates such a second vector MLP 228 and illustrates an example of the output as 230. Block 1230 may be followed by block 1240.

At block 1240, a quadrilateral mesh is generated. For example, after obtaining the output tangent vector fields in block 1230, various techniques may be used to obtain a quadrilateral mesh with edges aligned with the predicted tangent vector fields. Additional details of generating a quadrilateral mesh are presented above with respect to the discussion of FIG. 8.

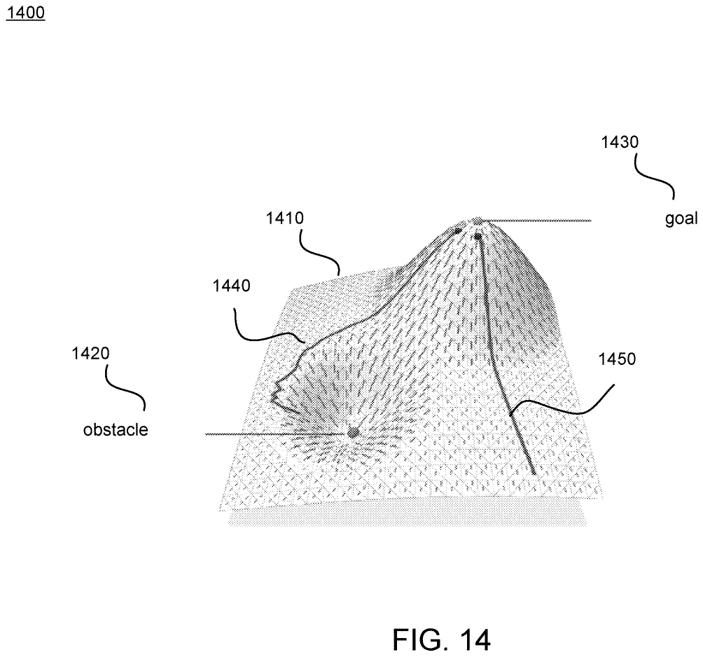

FIG. 12 is presented as a succession of blocks (1210, 1220, 1230, 1240), performed in a sequence. Method 1200 is not limited to these operations or this sequence. Further, additional operations may be performed in addition to or instead of these operations, or some of these operations may be omitted. For example, in some implementations, in lieu of generating a quadrilateral mesh at block 1240, the tangent vector fields are used in other ways, such as for robotic path planning as discussed in FIG. 14. This process may happen in parallel for multiple vertices at the same time.

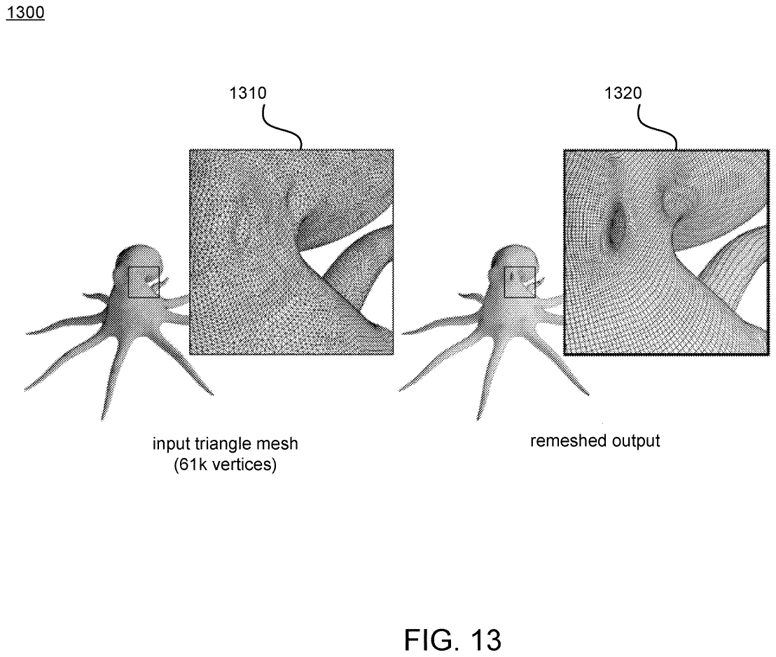

FIG. 13 is a diagram illustrating ways a method is scalable to high resolution input meshes 1300, in accordance with some implementations. FIG. 13 illustrates an input triangle mesh 1310 and a remeshed output 1320. The input triangle mesh 1310 includes about 61,000 vertices. Despite the large number of vertices, the presented techniques are able to generate a remeshed output 1320. Remeshed output 1320 is also remeshed with good quality (high fidelity to the original shape). FIG. 13 illustrates an input triangle mesh 1310 of an octopus and a remeshed output 1320 of an octopus.

FIG. 14 is a diagram illustrating ways tangent vector fields are used to guide robot path planning 1400, in accordance with some implementations. Tangent vector fields are commonly used to guide path planning for a robot. The techniques are trained to generate such a navigation vector field on the terrain mesh to assist motion planning as illustrated.

For example, FIG. 14 illustrates a terrain mesh 1410 having a vector field overlaid on the terrain mesh 1410. The terrain mesh 1410 includes an obstacle point 1420 and a goal point 1430. FIG. 14 also illustrates route 1440 and route 1450 which illustrate ways of directing a robot to follow the vector field to the goal point 1430 while avoiding the obstacle point 1420.

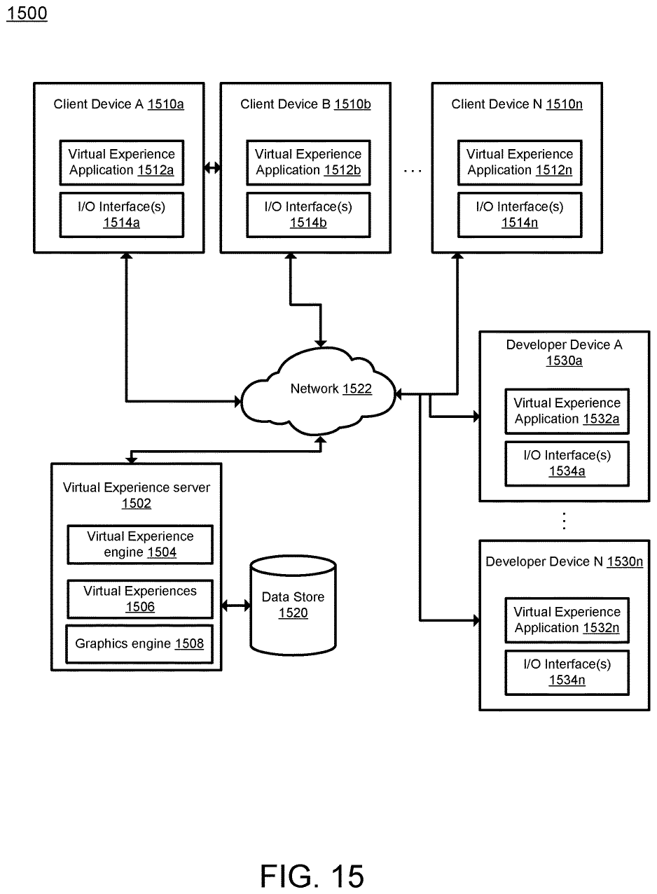

FIG. 15 is a diagram of an example system architecture 1500 that includes a 3D environment platform to train models to generate tangent vector fields that are intrinsically defined on manifold surfaces embedded in a three-dimensional (3D) space in accordance with some implementations. FIG. 15 and the other figures use like reference numerals to identify similar elements. A letter after a reference numeral, such as “1510,” indicates that the text refers specifically to the element having that particular reference numeral. A reference numeral in the text without a following letter, such as “1510,” refers to any or all of the elements in the figures bearing that reference numeral (e.g., “1510” in the text refers to reference numerals “1510a,” “1510b,” and/or “1510n” in the figures).

The system architecture 1500 (also referred to as “system” herein) includes online virtual experience server 1502, data store 1520, client devices 1510a, 1510b, and 1510n (generally referred to as “client device(s) 1510” herein), and developer devices 1530a and 1530n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowchart shown in FIG. 12. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

One or more characters (also referred to as an “avatar” or “model” herein) may be associated with a user where the user may control the character to facilitate a user's interaction with the virtual experiences 1506.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 1502. In some implementations, creating, modifying, or customizing characters, other virtual experience objects, virtual experiences 1506, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 1502 may store characters created by users in the data store 1520. In some implementations, the online virtual experience server 1502 maintains a character catalog and virtual experience catalog that may be presented to users. In some implementations, the virtual experience catalog includes images of virtual experiences stored on the online virtual experience server 1502. In addition, a user may select a character (e.g., a character created by the user or other user) from the character catalog to participate in the chosen virtual experience. The character catalog includes images of characters stored on the online virtual experience server 1502. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 1502.

In some implementations, the client device(s) 1510 may each include computing devices such as personal computers (PCs), mobile devices (e.g., laptops, mobile phones, smart phones, tablet computers, or netbook computers), network-connected televisions, gaming consoles, etc. In some implementations, a client device 1510 may also be referred to as a “user device.” In some implementations, one or more client devices 1510 may connect to the online virtual experience server 1502 at any given moment. It may be noted that the number of client devices 1510 is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

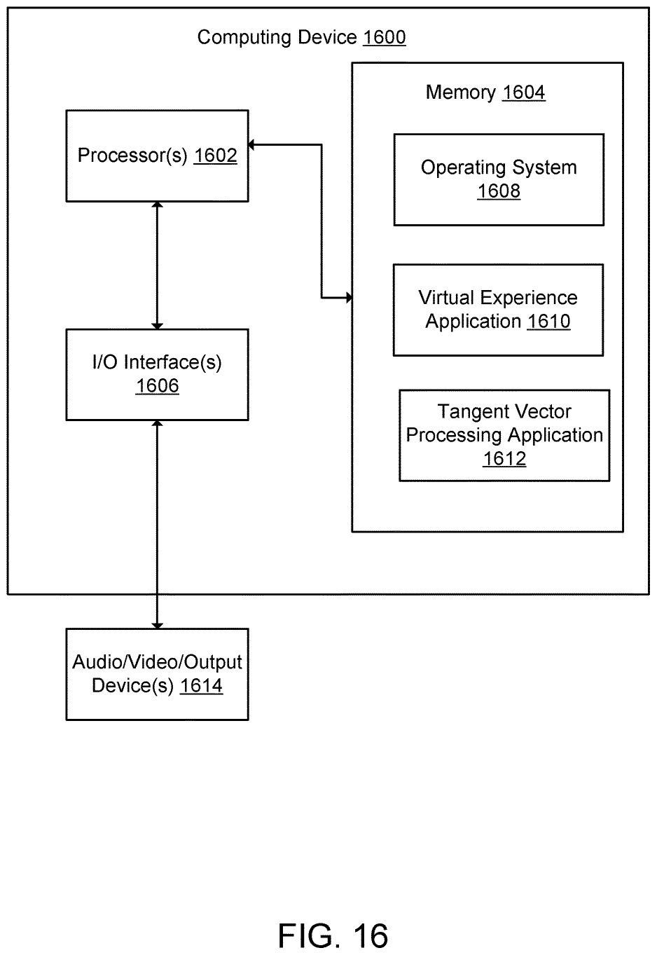

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interfaces 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a tangent vector processing application 1612, and other applications (not shown). In some implementations, virtual experience application 1610 and/or tangent vector processing application 1612 can include instructions that enable processor 1602 to perform the functions (or control the functions of) described herein, e.g., some or all of the methods described with respect to FIG. 12.

For example, virtual experience application 1610 can include a tangent vector processing application 1612, which as described herein can process tangent vector fields within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface(s) 1606 can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and tangent vector processing application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 1200) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to generate tangent vector fields on three-dimensional objects, the method comprising:
receiving as input features a set of tangent vectors defined on vertices of a triangle mesh for a surface, each tangent vector represented as a complex number;
transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and
outputting the set of tangent vector fields defined on the vertices as output features.

2. The computer-implemented method of claim 1, further comprising generating a quadrilateral mesh for the surface based on the set of tangent vector fields.

3. The computer-implemented method of claim 2, further comprising rendering the surface based on the quadrilateral mesh.

4. The computer-implemented method of claim 1, wherein the transforming is invariant to rigid motion of the surface, tangent bases of the surface, isometry of the surface, or a combination thereof.

5. The computer-implemented method of claim 1, wherein the vector heat diffusion module processes the set of tangent vectors by solving a vector heat equation using implicit Euler integration.

6. The computer-implemented method of claim 5, wherein solving the vector heat equation using implicit Euler integration comprises performing approximation using spectral acceleration to transform the set of tangent vectors into a set of diffused features.

7. The computer-implemented method of claim 6, wherein the spectral acceleration uses trainable time steps to transform the set of tangent vectors into the set of diffused features.

8. The computer-implemented method of claim 1, wherein the vector-valued multi-layer perceptron (MLP) includes a per-vertex linear layer to linearly combine complex-valued features at each vertex of the triangle mesh and apply non-linearities on magnitudes of respective complex-valued features of vertices of the triangle mesh.

9. The computer-implemented method of claim 1, wherein the vector-valued multi-layer perceptron (MLP) includes alternating complex linear and vector activation layers.

10. The computer-implemented method of claim 1, wherein the at least one vector diffusion block is preceded by an initial vector multi-layer perceptron (MLP) to prepare the set of tangent vectors for processing by modifying a number of dimensions of individual vectors in the set of tangent vectors.

11. The computer-implemented method of claim 1, wherein the at least one vector diffusion block is followed by a final vector MLP to prepare the set of tangent vector fields for output by modifying a number of dimensions of individual vector fields in the set of tangent vector fields.

12. The computer-implemented method of claim 1, wherein an output of the vector heat diffusion module is provided as input to the vector-valued MLP, and wherein the vector-valued MLP generates the set of tangent vector fields.

13. The computer-implemented method of claim 12, wherein the at least one vector diffusion block is configured with at least one skip connection whereby an output of the vector heat diffusion module is appended with the set of tangent vectors prior to provision as the input to the vector-valued MLP.

14. The computer-implemented method of claim 1, wherein the receiving, the transforming, and the outputting use a set of scalars in addition to or instead of the set of tangent vectors, each scalar represented as a real part of a complex number.

15. A non-transitory computer-readable medium with instructions stored thereon that, responsive to execution by a processing device, causes the processing device to perform operations comprising:
receiving as input features a set of tangent vectors defined on vertices of a triangle mesh for a surface, each tangent vector represented as a complex number;
transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and
outputting the set of tangent vector fields defined on the vertices as output features.

16. The non-transitory computer-readable medium of claim 15, wherein the transforming is invariant to rigid motion of the surface, tangent bases of the surface, isometry of the surface, or a combination thereof.

17. The non-transitory computer-readable medium of claim 15, wherein the vector heat diffusion module processes the set of tangent vectors by solving a vector heat equation using implicit Euler integration.

18. The non-transitory computer-readable medium of claim 15, wherein the vector-valued multi-layer perceptron (MLP) includes alternating complex linear and vector activation layers.

19. A system comprising:
a memory with instructions stored thereon; and
a processing device, coupled to the memory, the processing device configured to access the memory and execute the instructions, wherein the instructions cause the processing device to perform operations comprising:
receiving as input features a set of tangent vectors defined on vertices of a triangle mesh for a surface, each tangent vector represented as a complex number;
transforming the set of tangent vectors using at least one vector diffusion block iteratively until a termination condition is met to generate a set of tangent vector fields defined on the vertices, wherein each vector diffusion block comprises a vector heat diffusion module and a vector-valued multi-layer perceptron (MLP); and
outputting the set of tangent vector fields defined on the vertices as output features.

20. The system of claim 19, wherein the transforming is invariant to rigid motion of the surface, tangent bases of the surface, isometry of the surface, or a combination thereof.
